(19) United States
(12) Patent Application Publication
(10) Pub. No.: US 2024/0251275 A1
(43) Pub. Date: Jul. 25, 2024

(54) MECHANISM FOR REPORTING WITH CHANNEL STATUS WAVING

(71) Applicant: Nokia Technologies Oy, Espoo (FI)

(72) Inventors: Jingyuan SUN, Beijing (CN); Konstantinos MANOLAKIS, Munich (DE); Frank FREDERIKSEN, Aalborg (DK)

(21) Appl. No.: 18/560,845

(22) PCT Filed: Jul. 23, 2021
(86) PCT No.: PCT/CN2021/108287

§ 371 Date: Nov. 14, 2023

(51) Int. Cl. H04W 24/10

(52) U.S. Cl. CPC H04W 24/10

(57) ABSTRACT

Embodiments of the present disclosure propose a solution for reporting with channel status waving. According to embodiments of this present disclosure, a terminal device determines one or more time durations for reporting and preconfiguring with the channel status waving. The terminal device transmits parameters related to channel status and/or adjusts its power in accordance with the one or more time durations. In this way, it can improve the reporting of channel status information and configuration efficiency with reduced overhead.

### FIELD

Embodiments of the present disclosure generally relate to the field of telecommunication and in particular, to methods, devices, apparatuses and computer readable storage medium for reporting and configuring with channel status waving.

### BACKGROUND

The third generation partnership project (3GPP) has supported technologies of new radio (NR) on non-terrestrial networks (NTN). There are several type of satellite, Low Earth Orbiting (LEO) and Geostationary Earth Orbiting (GEO). For LEO, the satellite is moving with high speed. As the satellite is moving in the orbit, for LEO, the moving is predictable if only considering the orbit and not considering the fluctuation of the movement in the orbit because of solar radiation pressure. Moreover, a terminal device needs to report channel state information to a network device to improve communication performances. The terminal device also needs to save power according to the network configuration.

### SUMMARY

In general, example embodiments of the present disclosure provide a solution for reporting and configuring with channel status changing in NTN.

In a first aspect, there is provided a first device. The first device comprises at least one processor; and at least one memory including computer program codes; the at least one memory and the computer program codes are configured to, with the at least one processor, cause the first device to: determine a time duration for reporting channel status information; and transmit, to the second device, a set of one or more parameters related to the channel status information based on the time duration.

In a second aspect, there is provided a first device. The first device comprises at least one processor; and at least one memory including computer program codes; the at least one memory and the computer program codes are configured to, with the at least one processor, cause the first device to: receive, and from a second device, a configuration for power adjustment; determine a time duration for the power adjustment; and perform a transmission to the second device based on the configuration for the power adjustment during the time duration.

In a third aspect, there is provided a first device. The first device comprises at least one processor; and at least one memory including computer program codes; the at least one memory and the computer program codes are configured to, with the at least one processor, cause the first device to: receive, from a second device, a set of configurations for a number of candidates of a physical downlink channel for a set of aggregation levels associated with at least one time duration; and detect the physical downlink channel for a corresponding aggregation level of the set of aggregation levels in the at least one time duration.

In a fourth aspect, there is provided a second device. The second device comprises at least one processor; and at least one memory including computer program codes; the at least one memory and the computer program codes are configured to, with the at least one processor, cause the second device to: receive, at a second device and from a first device, a set of one or more parameters related to channel status information for a time duration.

In a fifth aspect, there is provided a second device. The second device comprises at least one processor; and at least one memory including computer program codes; the at least one memory and the computer program codes are configured to, with the at least one processor, cause the second device to: transmit, to a first device, a configuration for power adjustment; and receive a transmission from the first device based on the configuration for the power adjustment during a time duration.

In a sixth aspect, there is provided a second device. The second device comprises at least one processor; and at least one memory including computer program codes; the at least one memory and the computer program codes are configured to, with the at least one processor, cause the second device to: transmit, to a first device, a set of configurations for a number of candidates a physical downlink channel for a set of aggregation levels associated with at least one time duration; and transmit, to the first device, the physical downlink channel for a corresponding aggregation level of the set of aggregation levels in the at least one time duration.

In a seventh aspect, there is provided a method. The method comprises determining a time duration for reporting channel status information; and transmitting, to the second device, a set of one or more parameters related to the channel status information based on the time duration.

In an eighth aspect, there is provided a method. The method comprises receiving, at a first device and from a second device, a configuration for power adjustment; determining a time duration for the power adjustment; and performing a transmission to the second device based on the configuration for the power adjustment during the time duration.

In a ninth aspect, there is provided a method. The method comprises receiving, at a first device and from a second device, a set of configurations for a number of candidates of a physical downlink channel for a set of aggregation levels associated with at least one time duration; and detecting the first device and based on the received set of configurations, the physical downlink channel for a corresponding aggregation level of the set of aggregation levels in the at least one time duration.

In a tenth aspect, there is provided a method. The method comprises receiving, at a second device and from a first device, a set of one or more parameters related to channel status information for a time duration.

In an eleventh aspect, there is provided a method. The method comprises transmitting, at a second device and to a first device, a configuration for power adjustment; and receiving a transmission from the first device based on the configuration for the power adjustment during a time duration.

In a twelfth aspect, there is provided a method. The method comprises transmitting, at a second device and to a first device, a set of configurations for a number of candidates a physical downlink channel for a set of aggregation levels associated with at least one time duration; and transmitting, to the first device, the physical downlink channel for a corresponding aggregation level of the set of aggregation levels in the at least one time duration.

In a thirteenth aspect, there is provided an apparatus. The apparatus comprise means for performing the method according to any one of the above seventh, eighth, or ninth aspect.

In a fourteenth aspect, there is provided an apparatus. The apparatus comprises means for performing the method according to any one of the above tenth, eleventh, or twelfth aspect.

In a fifteenth aspect, there is provided a computer readable medium. The computer readable medium comprises program instructions for causing an apparatus to perform at least the method according to any one of the seventh, eighth, or ninth, tenth, eleventh, or twelfth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIGS. 1A and 1B illustrate example communication environments in which example embodiments of the present disclosure can be implemented;

FIGS. 2A and 2B illustrate example schematic diagrams of different channel quality information/channel state information for different terminal devices with different movement trajectory;

FIG. 3 illustrates a signaling flow for reporting channel quality information or channel state information according to some example embodiments of the present disclosure;

FIG. 4 illustrates a schematic diagram of a wave of channel quality information or channel state information according to some example embodiments of the present disclosure;

FIG. 5 illustrates an example schematic diagram of different signal to interference noise ratios (SINRs) for different terminal devices with different movement trajectory;

FIG. 6 illustrates a signaling flow for power adjustment according to some example embodiments of the present disclosure;

FIG. 7 illustrates a schematic diagram of power adjustment according to some example embodiments of the present disclosure;

FIG. 8 illustrates a signaling flow for blind detection according to some example embodiments of the present disclosure;

FIG. 9 illustrates a schematic diagram of satellite movements according to some example embodiments of the present disclosure;

FIG. 10 illustrates a flowchart of a method implemented at a first device according to some example embodiments of the present disclosure;

FIG. 11 illustrates a flowchart of a method implemented at a first device according to some example embodiments of the present disclosure;

FIG. 12 illustrates a flowchart of a method implemented at a first device according to some example embodiments of the present disclosure;

FIG. 13 illustrates a flowchart of a method implemented at a second device according to some other example embodiments of the present disclosure;

FIG. 14 illustrates a flowchart of a method implemented at a second device according to some other example embodiments of the present disclosure;

FIG. 15 illustrates a flowchart of a method implemented at a second device according to some other example embodiments of the present disclosure;

FIG. 16 illustrates a simplified block diagram of an apparatus that is suitable for implementing example embodiments of the present disclosure; and

FIG. 17 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. The term “terminal device” refers to any end device that may be capable of wireless communication. In the following description, the terms “terminal device”, “terminal”, “user equipment” and “UE” may be used interchangeably.

According to some conventional technologies, for one satellite, it may have multiple satellite beams, potentially combined with additional New Radio (NR) beams generated by the satellite antenna, to provide a large transmission/reception gain, so that the packet can be transmitted to the receiver side even with a large pathloss between the satellite and the UE (as the distance between the satellite and the UE is large, e.g. between 600 km and 1932 km for a LEO satellite with orbit altitude as 600 km and minimum elevation angle as 10 degree).

For some cases, one cell may contain multiple beams of the satellite, while for some cases, one cell contains only one beam of the satellite, e.g. one beam in the cell. The beam of satellite and beam of NR cell could be same beam or different beam. When same, beam of satellite can be replaced by beam of NR. When different, one satellite beam can cover more than one NR beam, or one NR beam can cover more than one satellite beam. One type of cell of NTN is an earth-moving cell, where along with the satellite moving, the coverage of the cell will also move accordingly. Along with the satellite moving, the UE may be covered by one beam in some time and then changed to the next beam.

For one beam, there is beam center and beam edge. Generally, the beam center can provide larger transmission/reception gain (e.g. 3 dB) than the beam edge. This is a physical property of the way that the beams are generated, and would generally not be possible to change. In general, the physical channel between the UE and the satellite is mainly LOS, which means that the channel gain is mainly determined by the UE location and the distance to the satellite.

Channel status information (CSI) is important at the wireless network, where transmission/reception should be adapted to the channel status in order to achieve a success transmission. Following three items are related to channel status and need to be reported by the UE or configured from a Node B in terrestrial network, and all these will cause overhead, especially when frequent reporting or configuration is needed along with the frequent changing of channel status with serving beam changing.

As a first item, in both TN and NTN, the UE needs to report DL channel status, e.g. channel quality information (CQI), to the gNB. There is periodic and aperiodic CQI feedback, with feedback overhead. Especially, when channel status changes, it is requested for the UE to report the new CQI as assistance for scheduler to allocate the resource for channels to different UEs. In NTN, since the distance to satellites is generally large, the generated cells may typically be relative large (cell radius of 50-300 km), which in turn might cause a quite high number of UEs within a cell. This can potentially cause the gNB to configure a large number of UL resources to be used for CQI feedback—especially if the gNB need to have updated CQI information for the larger portion of the UEs.

A second item related to channel status and causing additional overhead is the configuration of closed loop power control. In NTN, when the satellite is moving, the distance between the UE and the gNB is changing and UE may be covered by different beams and with different beamforming gains (e.g. higher gain when the UE is at beam center, while lower gain when the UE is at beam edge) along the time. For achieving a target reception power level at the UE, the gNB needs to maintain multiple closed loop power control procedures over time for all the UL related transmissions, with a corresponding large overhead for the information exchange.

A third item related to channel status and causing overhead as well is the configuration of physical downlink control channel (PDCCH) search space and blind detection. In NTN, when satellite is moving, the distance between the UE and the Node B is changing and the UE may be served by different beams and by different beamforming gain (e.g. higher gain when the UE is served by beam center, while lower gain when the US is served by beam edge) along the time, the PDCCH reception SINR will change accordingly. Considering channel status, a UE with better channel status may need less control channel element (CCE) resources to receive the PDCCH with same overhead comparing to a UE with worse channel status, i.e. a better channel status, the smaller CCE aggregation level needed. PDCCH in one cell is at PDCCH resource set(s) and the resource set(s) are shared by all UEs in the cell and their resource size is limited. Node B will configure UE's search space and candidates of PDCCH for blind detection for each CCE aggregation level. For PDCCH search space and candidates for each CCE aggregation level (AL), especially candidates for each CCE AL, it should be aligned with the channel status, or there may be no chance for Node B to select good resource/CCE number for UE and the UE may not able to correctly receive the PDCCH, or there may be resource waste for PDCCH.

All the possible locations for PDCCH can be called “Search Space” and each of the possible location is called “PDCCH Candidate”. The search space can indicate the set of CCE locations where the UE may find its PDCCHs. Each PDCCH carries one DCI and is identified by radio network temporary identity (RNTI).

When the channel status changes or frequency of change status drift rate changes, in terrestrial network, the Node B will change and reconfigure the CQI feedback period, closed loop power control, number of blind detection candidates for each CCE level. But the overhead is still there, and the more frequent changing of the channel status, the more overhead for periodic or aperiodic CQI feedback and/or the more overhead is needed for the reconfiguration and configuration of closed loop power control, number of blind detection candidates for each CCE level. In NTN, the reconfiguration will be much more frequent than in TN considering satellite movement, which results a large overhead.

Therefore, a solution for reporting with channel status waving is proposed. By waving, it is meant that the UE's CSI may experience wave-like pattern, due to the satellite/NTN beam/cell changing from one beam/cell to another. According to embodiments of this present disclosure, a terminal device determines one or more time durations for reporting and preconfiguring with the channel status waving. The terminal device transmits parameters related to channel status and/or adjusts its power in accordance with the one or more time durations. In this way, it can improve the efficiency of channel status information reporting and/or configuration for power adjustment or PDCCH monitoring with reduced overhead. Moreover, since there is overhead reduction for reporting/configuration, resources can be saved for feedback and configuration. In addition, it can also save power for the reporting/configuration when channel status change frequently along with satellite moving.

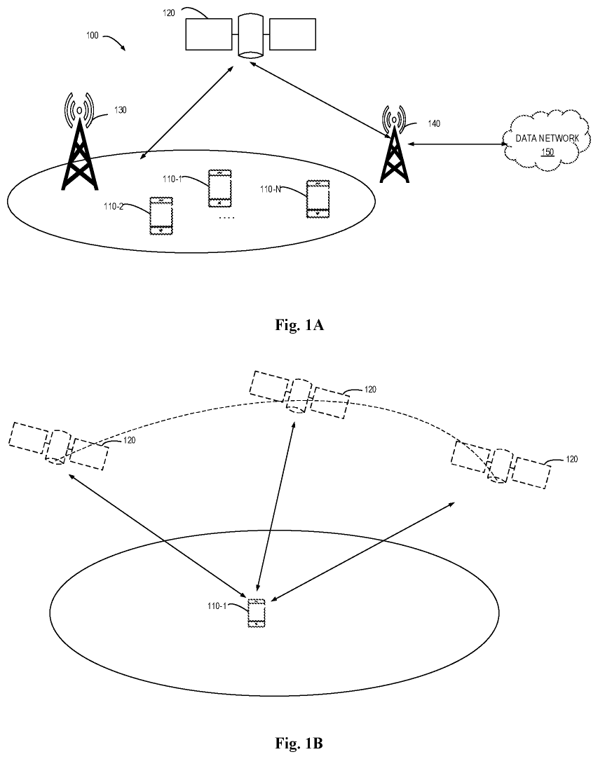

FIG. 1A illustrates a schematic diagram of a communication environment 100 in which embodiments of the present disclosure can be implemented. The communication environment 100, which is a part of a communication network, further comprises a device 110-1, a device 110-2, . . . , a device 110-N, which can be collectively referred to as “first device(s) 110.” The communication environment 100 comprises a second device 120. The second device 120 can be a non-terrestrial device, for example, a satellite. The communication environment 100 can comprise a network device 130 and a gateway 140 which connects with a data network 150. The first device 110 can be a terrestrial communication device while the second device 120 can be a non-terrestrial communication device. Only as an example, as shown in FIG. 1B, the second device 120 is a satellite which serves the first device 110-1 and the second device 120 is moving along its orbit. The second device can also be the network device 140.

The communication environment 100 may comprise any suitable number of devices and cells. In the communication environment 100, the first device 110 and the second device 120 can communicate data and control information to each other. In the case that the first device 110 is the terminal device and the second device 120 is the network device, a link from the second device 120 to the first device 110 is referred to as a downlink (DL), while a link from the first device 110 to the second device 120 is referred to as an uplink (UL). When second device is 140, then the DL is the link from 140 to 120 and then to 110, while the UL is from 110 to 120 and then to 140. In some embodiments, the regenerative architecture can be applied to the communication environment 100. Alternatively, a bent-pipe architecture can be applied to the communication environment 100.

It is to be understood that the number of first devices and cells and their connections shown in FIG. 1 is given for the purpose of illustration without suggesting any limitations. The communication environment 100 may include any suitable number of devices and networks adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Along with satellite moving, the reported CQI can be with a trend, i.e. in a few or tens of seconds when the terminal device is covered by one satellite. The CQI may change from one low level to one higher level and then change back to low level in each beam of the serving cell. The changing may follow a pattern, i.e. changing speed, changing step and the like. CQI between the beam center and beam edge may have 3 dB difference, but also with predication, combined with satellite moving.

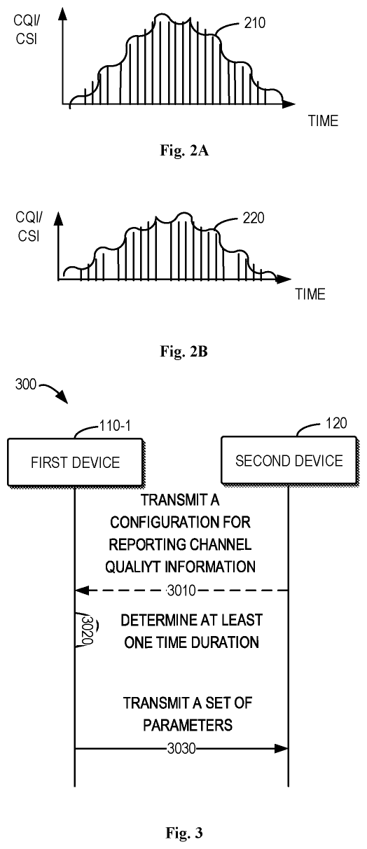

FIGS. 2A and 2B illustrate example schematic diagrams of different channel quality information/channel state information for different terminal devices with different movement trajectory. As shown in FIG. 2A, the value of the CQI/CSI 210 of the device 110-1 can vary along with the time. Similarly, as shown in FIG. 2B, the value of the CQICSI 220 of the device 110-2 can vary along with the time. Different devices with different movement trajectory can have different CQI/CSI waving.

Reference is now made to FIG. 3, which illustrates a signaling flow 300 for reporting channel quality information or channel state information according to example embodiments of the present disclosure. For the purpose of discussion, the signaling flow 300 will be described with reference to FIG. 1. Only for the purpose of illustrations, the signaling flow 300 may involve the first device 110-1 and the second device 120.

The second device 120 may transmit 3010 a configuration for reporting channel status information to the first device 110-1. For example, the channel status information can comprise channel state information. Alternatively or in addition, the channel status information can comprise channel quality information. In some embodiments, the configuration can be transmitted via radio resource control (RRC) signaling. Alternatively, the configuration can be transmitted via medium access control (MAC) signaling. In other embodiments, the second device 120 can transmit the configuration in downlink control information (DCI). In some embodiments, the configuration may be transmitted together with any of additional configurations.

In some embodiments, the second device 120 can configure a reference interference level or interference levels in the time line for the first device 110-1 to determine the CQI/CSI in different time. In other words, the configuration for reporting the channel status information can comprise information related a reference interference level for determining the channel status information over the time duration. In some embodiments, the reference interference level for determining the channel status information for the time duration is same as another reference interference level for determining the channel status information over another time duration. Alternatively, the configuration may comprise information related to a first reference interference level for determining the channel status information for the time duration and a second first reference interference level for determining the channel status information for the other time duration. Alternatively or in addition, the second device 120 can configure one or more time slot indexes that the CQI/CSI is related to. In other embodiments, the second device 120 can configure one or more time period that the CQI/CSI is related to. In this case, the configuration for reporting the channel status information can comprise information related to a time slot index or a time period that the channel status information is related to. In other embodiments, the configuration for reporting the channel status information can comprise information for a time slot index or time period that the set of parameter is related to.

The first device 110-1 determines 3020 a time duration for reporting the channel status information. For example, the time duration can be determined based on a network configuration. Only as an example, the time duration can be determined based on a maximum value of the wave. Alternatively or in addition, the time duration can be determined based on UE's prediction of the beams of the satellite to serve the first device, e.g. based on history information or predefined information, etc. Alternatively or in addition, the time duration can be determined based on a beginning and/or an ending time of the wave. In other embodiments, the time duration can also be determined based on a speed of the second device 120. Embodiments of the present disclosure are not limited to this aspect.

In some embodiments, the first device 110-1 may determine the time duration based on predictable received signal strength characteristics. Alternatively or in addition, the first device 110-1 may determine the time duration based on predictable movement of a NTN node (for example, a satellite). In another embodiment, the first device 110-1 may determine the time duration based on a predictable beam changing. In other embodiments, the first device 110-1 may determine the time duration based on a network configuration.

Alternatively, the second device 120 may determine the time duration. Similarly, the second device 120 may determine the time duration based on predictable received signal strength characteristics. Alternatively or in addition, the second device 120 may determine the time duration based on predictable movement of a NTN node (for example, a satellite). In other embodiments, the second device 120 may determine the time duration based on a predictable beam changing. In this case, the second device 120 may transmit information for the time duration and the number of the time duration.

In some embodiments, the second device 120 may transmit the information for beam changing. Such information for beam changing may comprise any information element enabling the UE to determine when the serving beam is/will change. This may comprise e.g. time instants when the serving beam is/will change, or trajectory information of the NTN satellite, for example. Alternatively or in addition, the second device 120 may transmit the information for movement of NTN node. In other embodiments, the second device 120 may transmit information for received signal strength characteristics. The above information can be transmitted in the configuration sent at 3010. Alternatively, the above information can be transmitted separately from the configuration sent at 3010.

In some embodiments, values of the CQI/CSI can be alternately increasing and decreasing in the time duration. Alternatively or in addition, the increasing part can last for a first portion of the time duration and the decreasing part can last for a second portion of the time duration. Alternatively or in addition, the increasing part can last for entire duration of one part of the time duration, or, the decreasing part can last entire duration of another part of time duration of the time duration. The first device 110-1 can also determine a number of the time duration. Values of the channel status information can be increasing within a first portion of the time duration and the values can be decreasing within a second portion of the time duration. Alternatively or in addition, values of the channel status information can be increasing within entire duration of one part of the time duration and the values can be decreasing within entire duration of another part of time duration of the time duration.

In some embodiments, the time duration could be corresponding to the time starting from a beam center serving the UE to the beam edge serving the UE or starting from a beam edge to the beam center, then the channel status may change continuously decreasing or increasing correspondingly. Or the time duration could be corresponding to the time starting from a beam edge serving the UE to the beam another edge serving the UE, then the channel status may change firstly increasing then decreasing correspondingly.

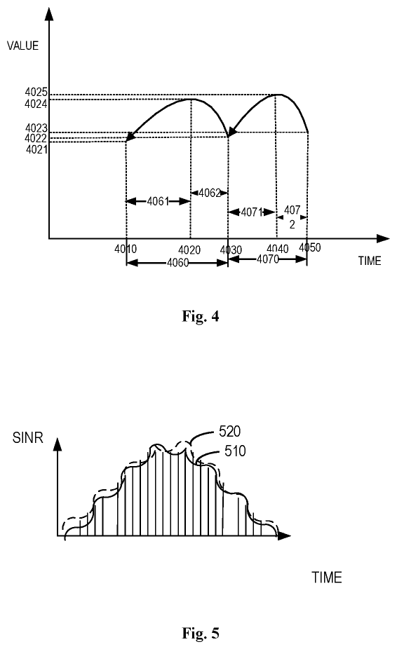

For example, as shown in FIG. 4, the first device 110-1 can determine the time duration 4060 and the time duration 4070. In this case, the number of the time durations is 2. Each time duration can comprise one wave or half a wave or part of a wave, for example. The values of the CQI/CSI can increase within the first portion 4061 within the time duration 4060 and decrease within the second portion 4062 within the time duration 4060. Similarly, the values of the CQI/CSI can increase within the first portion 4071 within the time duration 4070 and decrease within the second portion 4072 within the time duration 4070.

In some embodiments, the first device 110-1 can determine at least one period for reporting the channel status information within the time duration. In this case, the first device 110-1 may determine the number of the at least one period for each of the at least one time duration. The period can also refer to a time duration which is shorter than the determined 3020 time duration. In some embodiments, the period can be a gap between two reporting of the channel status information. Such channel status information can be called periodic channel status information, for example. For each time duration, the channel status information can be reported for each period in the time duration. For example, the size/length of the reporting period can be continuously increasing in part or entire time of the at least one time duration. Alternatively, the size of the reporting period can be continuously decreasing in part or entire time of the time duration. In some embodiments, the size of the reporting period can be continuously decreasing in a first part in each time duration of the time durations and the size of the reporting period can be continuously increasing in a second part in each time duration of the time durations. For example, as shown in FIG. 4, the time duration 4060 may comprise more than one reporting period which is not shown in FIG. 4. Only as an example, the values of the CQICSI within the duration 4061 are changing slower than the values of CQI/CSI within the duration 4062. In this situation, the size of the reporting period can be continuously decreasing in the duration 4061 and the size of the reporting period can be continuously increasing in the duration 4062.

The first device 110-1 transmits 3030 a set of parameters related to the channel status information. The set of parameters can comprise any suitable number of parameters. In some embodiments, for the serving cell, the set of parameters can comprise the number of CQI/CSI waving (or the number of the time durations), where one waving includes one part with CQI increasing and then one part with CQI decreasing. The set of parameters may also comprise a changing rate of the channel status information. Alternatively or in addition, the set of parameters may comprise a starting value of the channel status information. In other embodiments, the set of parameters can comprise a maximum value of the channel status information. The set of parameters may also comprise an ending value of the channel status information. Alternatively, the set of parameters can comprise the maximum value and minimum value of the channel status information. In this case, the set of parameters can also comprise a changing pattern of the channel status information.

Reference is made to FIG. 4. In some embodiments, the set of parameters can comprise one or more of the followings for the time duration 4060: the maximum value 4024, the minimum value, an increasing rate of the channel status information within the duration 4061, a decreasing rate of the channel status information within the duration 4062, a changing rate of the channel status information, a starting value 4021 of the channel status information in the time duration 4060, an ending value 4022 of the channel status information in the time duration 4060, and the changing pattern during the time duration 4060. In addition, the set of parameters can comprise one or more of the followings for the time duration 4070: the maximum value 4025, the minimum value, an increasing rate of the channel status information within the duration 4071, a decreasing rate of the channel status information within the duration 4072, a changing rate of the channel status information, a starting value 4022 of the channel status information in the time duration 4070, an ending value 4023 of the channel status information in the time duration 4070, and the changing pattern during the time duration 4070.

Alternatively or in addition, in some embodiments, the set of parameters can comprise one or more of the followings for the time duration 4060: a time instant 4020 for the maximum value 4024, a time instant of the minimum value, a time instant 4010 for the starting value 4021 of the time duration 4060, and a time instance 4030 for the ending value 4022 of the time duration 4060. Additionally, in some embodiments, the set of parameters can comprise one or more of the followings for the time duration 4070: a time instant 4040 for the maximum value 4025, a time instant of the minimum value, a time instant 4030 for the starting value 4022 of the time duration 4070, and a time instance 4060 for the ending value 4023 of the time duration 4070.

In other embodiments, the set of parameters can comprise a set of values of the channel status information and the duration time for each of the set of values. In some embodiments, the duration can be a period of semi-persistent scheduling. Alternatively or in addition, the set of parameters can comprise a drift rate of the channel status information, the value of the channel status information on some time slot and the later drift rate.

In this way, the network can interpret the channel status of UE in the entire time duration based on the received channel status information, e.g. considering the max or min value of CQI and the changing rate of the CQI.

In some embodiments, the second device 120 may schedule the first device 110-1 based on the report of the channel status information on the wave in time line. In some embodiments, the first device 110-1 may report the differential channel status information compared with the long-term channel status information. As one example, the long-term channel status information is based on the reported parameters for the channel status information. The differential channel status information can be transmitted based on UE measurements. The differential channel status information can be reported periodically or aperiodically or in addition to the set of parameters. In some embodiments, the granularity for trend and the differential CQI can change along the time. In this case, the second device 120 may schedule the first device 110-1 based on the report of the channel status information on the wave in time line and the reported differential channel status information. In this way, it improves the reporting of the channel status information and configuration efficiency with reduced overheads.

FIG. 5 illustrates an example schematic diagram of SNIRs for different terminal devices. As shown in FIG. 5, the value of the SNIR 510 of the device 110-1 can vary along with the time and the value of the SINR 520 of the device 110-2 can vary along with the time. Considering SINR waving (because of different beamforming gain at beam center and beam edge) along with time, closed loop power control (CLPC) can be configured accordingly, for power control solution considering constant target receiving power.

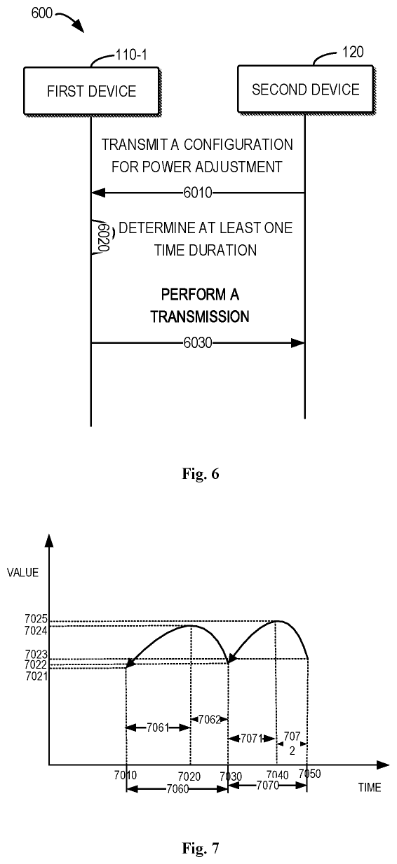

Reference is now made to FIG. 6, which illustrates a signaling flow 600 for power adjustment according to example embodiments of the present disclosure. For the purpose of discussion, the signaling flow 600 will be described with reference to FIG. 1. Only for the purpose of illustrations, the signaling flow 600 may involve the first device 110-1 and the second device 120.

The second device 120 transmits 6010 a configuration for power adjustment to the first device 110-1. In some embodiments, the configuration can be transmitted via radio resource control (RRC) signaling. Alternatively, the configuration can be transmitted via medium access control (MAC) signaling. In other embodiments, the second device 120 can transmit the configuration in downlink control information (DCI).

In some embodiments, the second device 120 can configure UL power configuration to the first device 110-1, for example, a closed loop power control. In some embodiments, for the serving cell, the configuration for power adjustment can comprise the number of power adjustment waving (or the number of the time durations), where one waving includes one part with power adjustment increasing and then one part with power adjustment decreasing. The configuration for power adjustment may also comprise a changing rate of the power adjustment. Alternatively or in addition, the configuration for power adjustment may comprise a starting value of the power adjustment (e.g. the transmitting power value to be used by the UE at the start of the time duration). In other embodiments, the configuration for power adjustment can comprise a maximum value of the power adjustment. The configuration for power adjustment may also comprise an ending value of the power adjustment. Alternatively, the configuration for power adjustment can comprise the maximum value and minimum value of the power adjustment. In this case, the configuration for power adjustment can also comprise a changing pattern or changing rate of the power adjustment.

Reference is made to FIG. 7. In some embodiments, the configuration for power adjustment can comprise one or more of the followings for the time duration 7060: the maximum value 7024, the minimum value, an increasing rate of the power adjustment within the duration 7061, a decreasing rate of the power adjustment within the duration 7062, a changing rate of the power adjustment, a starting value 7021 of the power adjustment in the time duration 7060, an ending value 7022 of the power adjustment within the time duration 7060, and the changing pattern or changing rate during the time duration 7060. In addition, the set of parameters can comprise one or more of the followings for the time duration 7070: the maximum value 7025, the minimum value, an increasing rate of the power adjustment within the duration 7071, a decreasing rate of the power adjustment within the duration 7072, a changing rate of the power adjustment, a starting value 7022 of the power adjustment in the time duration 7070, an ending value 7023 of the power adjustment in the time duration 7070, and the changing pattern or changing rate during the time duration 7070.

Alternatively or in addition, in some embodiments, the first device 110-1 can determine a set of parameters related to the power adjustment based on the configuration. For example, in some embodiments, the set of parameters can comprise one or more of the followings for the time duration 7060: a time instant 7020 for the maximum value 7024, a time instant of the minimum value, a time instant 7010 for the starting value 7021 of the time duration 7060, and a time instance 7030 for the ending value 7022 of the time duration 7060. Additionally, in some embodiments, the set of parameters can comprise one or more of the followings for the time duration 7070: a time instant 7040 for the maximum value 7025, a time instant of the minimum value, a time instant 7030 for the starting value 7022 of the time duration 7070, and a time instance 7060 for the ending value 7023 of the time duration 7070.

In other embodiments, the set of parameters can comprise a set of values of the power adjustment and the duration time for each of the set of values. Alternatively or in addition, the set of parameters can comprise a drift rate of the power adjustment, the value of the power adjustment on some time slot and the later drift rate.

The first device 110-1 determines 6020 a time duration for the power adjustment. For example, the time duration can be determined based on a network configuration. Only as an example, the time duration can be determined based on a maximum value of the wave. Alternatively or in addition, the time duration can be determined based on a beginning and/or an ending time of the wave. In other embodiments, the time duration can also be determined based on a speed of the second device 120. Embodiments of the present disclosure are not limited to this aspect.

In some embodiments, the first device 110-1 may determine the time duration based on predictable received signal strength characteristics. Alternatively or in addition, the first device 110-1 may determine the time duration based on predictable movement of a NTN node (for example, a satellite). In other embodiments, the first device 110-1 may determine the time duration based on a predictable beam changing.

Alternatively, the second device 120 may determine the time duration. Similarly, the second device 120 may determine the time duration based on predictable received signal strength characteristics. Alternatively or in addition, the second device 120 may determine the time duration based on predictable movement of a NTN node (for example, a satellite). In other embodiments, the second device 120 may determine the time duration based on a predictable beam changing. In this case, the second device 120 may transmit information for the time duration and the number of the time duration.

In some embodiments, the second device 120 may transmit the configuration based on beam changing. Alternatively or in addition, the second device 120 may transmit the configuration based on movement of NTN node. In other embodiments, the second device 120 may transmit configuration based on received signal strength characteristics. The above information can be transmitted in the configuration sent at 6010. Alternatively, the above information can be transmitted separately from the configuration sent at 6010.

In some embodiments, values of the power adjustment can be alternately increasing and decreasing in the time duration. Alternatively or in addition, the increasing part can last for a first portion of the time duration and the decreasing part can last for a second portion of each time duration of the time duration. Alternatively or in addition, the increasing part can last for a part of time duration of the time duration and the decreasing part can last for another part of time duration of the time duration. The first device 110-1 can also determine a number of the time duration. Values of the power adjustment can be increasing within a first portion of each time duration of the time duration and the values can be decreasing within a second portion of each time duration of the time duration. Alternatively or in addition, values of the power adjustment can be increasing within a part of the time duration and the values can be decreasing within another part of the time duration. In some embodiments, the time duration could be corresponding to the time starting from a beam center serving the UE to the beam edge serving the UE or starting from a beam edge to the beam center, then the power adjustment may change continuously decreasing or increasing correspondingly. Or the time duration could be corresponding to the time starting from a beam edge serving the UE to the beam another edge serving the UE, then the power adjustment may change firstly decreasing then increasing correspondingly.

For example, as shown in FIG. 7, the first device 110-1 can determine the time duration 7060 and the time duration 7070. In this case, the number of the time durations is 2. The values of the power adjustment can increase within the first portion 7061 within the time duration 7060 and decrease within the second portion 7062 within the time duration 7060. Similarly, the values of the power adjustment can increase within the first portion 7071 within the time duration 7070 and decrease within the second portion 7072 within the time duration 7070.

In some embodiments, the first device 110-1 can determine at least one period for the power adjustment within the time duration. In this case, the first device 110-1 may determine the number of the at least one period for each of the time duration. The period can also refer to a time duration which is shorter than the determined (6020) time duration. In some embodiments, the period can be a gap between two different values to be used. For each time duration, the power adjustment can be performed for each period in the time duration. For example, the size of the period can be continuously increasing in part of the time duration. Alternatively, the size of the period can be continuously decreasing in part of the time duration. In some embodiments, the size of the period can be continuously decreasing in a first part of the time duration and the size of the period can be continuously increasing in a second part of the time duration. For example, as shown in FIG. 7, the time duration 7060 may comprise more than one period which is not shown in FIG. 7. Only as an example, the values of the power adjustment within the duration 7061 are changing slower than the values of the power adjustment within the duration 7062. In this situation, the size of the period can be continuously decreasing in the duration 7061 and the size of the period can be continuously increasing in the duration 7062.

In some embodiments, the differential power adjustment can be absolute transmission power control (TPC). Alternatively, the differential power adjustment can be accumulating TPC.

In this way, UE can interpret the power adjustment for the UE in the entire time duration, e.g. considering the max or min value of power adjustment and the changing rate of the power adjustment, the starting value could be the max or min value then changing as the changing rate.

The first device 110-1 performs 6030 a transmission to the second device 120 based on the configuration for the power adjustment and the time duration. In some embodiments, the first device 110-1 may configure a differential power adjustment. The differential power adjustment can be absolute transmission power control (TPC). Alternatively, the differential power adjustment can be accumulating TPC. The differential power adjustment can be reported periodically or aperiodically or in addition to the set of parameters. In this case, the first device 110-1 can perform the transmission based on the configured waves of the power adjustment and the different power adjustment at a corresponding time slot. In this way, it improves power efficiency.

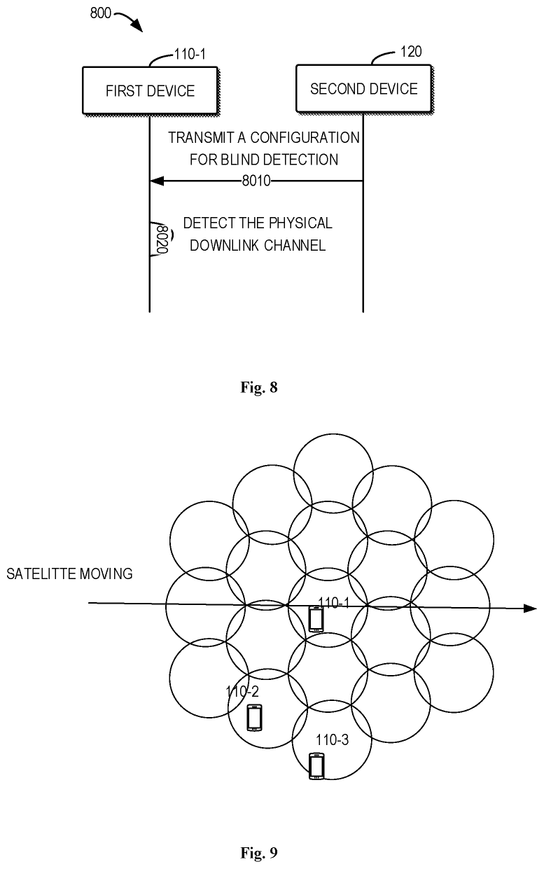

Reference is now made to FIG. 8, which illustrates a signaling flow 800 for transmitting candidates of a physical downlink channel for a set of aggregation levels according to example embodiments of the present disclosure. For the purpose of discussion, the signaling flow 800 will be described with reference to FIG. 1. Only for the purpose of illustrations, the signaling flow 800 may involve the first device 110-1 and the second device 120.

The second device 120 transmits 8010 a set of configurations for number of candidates of a physical downlink channel for each aggregation level associated with a time duration. The term “aggregation level” used herein refers to the number of CCEs required to carry one PDCCH. The term “blind detection” or “blind decoding” used herein refers to an operation to allow the UE to gather control information related to the downlink shared channel. The UE attempts the decoding of a set of candidates determined by combinations of system parameters to identify if one of the candidates hold its control information.

In some embodiments, the time duration can be configured by the second device 120. Alternatively or in addition, the number of the time durations can be configured by the second device 120. In some embodiments, the set of configurations for candidates can be transmitted via radio resource control (RRC) signaling. Alternatively, the set of configurations for candidates can be transmitted via medium access control (MAC) signaling. In other embodiments, the second device 120 can transmit the set of configurations for candidates in downlink control information (DCI). Table 1 below shows an example of the set of configurations for candidates. It should be noted that Table 1 is only an example.

TABLE 1

| | |
|---|---|
| nrofCandidates | SEQUENCE{ |
| aggregationLevel 1 | ENUMERATED {n0, n1, n2, n3, n4, n5, n6, n8}, |
| aggregationLevel 2 | ENUMERATED {n0, n1, n2, n3, n4, n5, n6, n8}, |
| aggregationLevel 4 | ENUMERATED {n0, n1, n2, n3, n4, n5, n6, n8}, |
| aggregationLevel 8 | ENUMERATED {n0, n1, n2, n3, n4, n5, n6, n8}, |
| aggregationLevel 16 | ENUMERATED {n0, n1, n2, n3, n4, n5, n6, n8}, |
| } | OPTIONAL |

In some embodiments, the set of configurations can indicate a first number of candidates for at least a first aggregation level is increasing in a first part of the time duration and a second number of candidates for at least a second aggregation level is decreasing in the first part of the time duration. Alternatively or in addition, the set of configurations can indicate the first number of candidates for at least the first aggregation level is decreasing in a second part of each time duration of the time duration and the second number of the candidates for at least the second aggregation level is increasing in the second part of each time duration of the time duration. Here, the first part or second part can be part or entire of the time duration. In other embodiments, the set of configurations can indicate a number of candidates for at least one of aggregation level associated with each of the at least one time duration. In an example embodiment, the set of configurations can indicate one or more of: a maximum number of candidates for at least one of aggregation level associated with each of the at least one time duration, a minimum number of candidates for at least one of aggregation level associated with each of the at least one time duration, or a changing rate for the candidates for at least one of aggregation level associated with each of the at least one time duration.

For example, in some embodiments, the second device 120 can configure waves of the candidates for blind detection distribution for aggregation levels (ALs), where there is part for increasing number of blind detection (BD) for at least one of AL=1/2/4 and decreasing number of BD for at least one of AL=16/8/4 and one part for decreasing number of BD for at least one of AL=1/2/4 and increasing number of BD for at least one of AL=16/8/4. Alternatively or in addition, the second device 120 can configure multiple blind detection distribution and the time slots/duration to use for each of them. In other embodiments, the second device 120 can configure changing rate for blind detection distribution of each ALs.

In some embodiments, values of the number of candidates for at least a first aggregation level can be alternately increasing and decreasing in the at least one time duration. Alternatively or in addition, the increasing part can last for a first portion of each time duration of the at least one time duration and the decreasing part can last for a second portion of each time duration of the at least one time duration. Alternatively or in addition, the increasing part can last for a part of time duration of the at least one time duration and the decreasing part can last for another part of time duration of the at least one time duration. The first device 110-1 can also determine a number of the time duration. Values of the number of candidates for at least a first aggregation level can be increasing within a first portion of each time duration of the at least one time duration and the values can be decreasing within a second portion of each time duration of the at least one time duration. Alternatively or in addition, values of the number of candidates for at least a first aggregation level can be increasing within a part of time duration of the at least one time duration and the values can be decreasing within another part of time duration of the at least one the time duration.

In some embodiments, the time duration could be corresponding to the time starting from a beam center serving the first device 110-1 to the beam edge serving the first device 110-1 or starting from a beam edge to the beam center, then the number of candidates for at least a first aggregation level may change continuously decreasing or increasing correspondingly. Or the time duration could be corresponding to the time starting from a beam edge serving the first device 110-1 to the beam another edge serving the first device 110-1, then the number of candidates for at least a first aggregation level may change firstly increasing then decreasing correspondingly or firstly decreasing then increasing correspondingly.

In this way, the first device 110-1 can interpret the number of candidates for at least a first aggregation level for the first device 110-1 in the entire time duration, e.g. considering the max or min value of the number of candidates for at least a first aggregation level and the changing rate of the number of candidates for at least a first aggregation level, the starting value could be the max or min value then changing as the changing rate.

In some embodiments, the set of configurations can also indicate one or more of: a first time instant or time range for a maximum number of candidates for at least one of aggregation level, a second time instant or time range for a minimum number of candidates for at least one of aggregation level, a third time instant or time range for a starting number of candidates for at least one of aggregation level, or a fourth time instant or time range for an ending number of candidates for at least one of aggregation level.

The first device 110-1 detects 8020 the physical downlink channel for a corresponding aggregation level of the set of aggregation levels on a corresponding time duration in the set of time durations. In this way, it can reduce the overhead.

In some embodiments, the first device 110-1 may determine at least one period for detecting the physical downlink channel within the at least one time duration. The period can refer to a gap between two values to be used. The second device 120 may also transmit a configuration of differential information of the number of candidates. The differential information of the number of candidates can be transmitted periodically or aperiodically or in addition to the set of configurations. In this case, the first device 110-1 can detect the physical downlink channel based on the plurality of candidates and the differential information of the number of candidates.

In some embodiments, as shown in FIG. 9, for different terminal devices with different trajectories, there may be different number of waves and different component waves when the serving cell/satellite serves the UE. Therefore, the terminal devices 110-1, 110-2 and 1103 may report or be configured with different number of the time duration (corresponding to different number of waves) for the channel status information reporting or configuration of CLPC/PDCCH monitoring. For example, the terminal device 110-1 may go through five cells/beams//waves as the satellite passes by, while the terminal device 110-2 goes through three cells/beams//waves and the terminal device 110-3 goes through only one. Also the waves that serve the UEs are different.

In an embodiment, the terminal device may determine configuration for one or more time durations, each time duration corresponding to a wave or half of a wave or part of a wave. The configuration may be based on configuration information received from network for the one or more time durations. The configuration may be based on a predetermined pattern of UE's received signal strength which is expected to vary substantially in a predetermined manner in an NTN network. The UE may apply the configuration/(s) during the time duration(s). In one embodiment the configuration(s) may define how the UE reports uplink information, such as CSI, during each time duration, as described above. In another embodiment, the configuration(s) may define how the terminal device adjusts uplink transmission power during each time duration, as described above. In another embodiment, the configuration(s) may define how the UE performs blind decoding during each time duration, as described above.

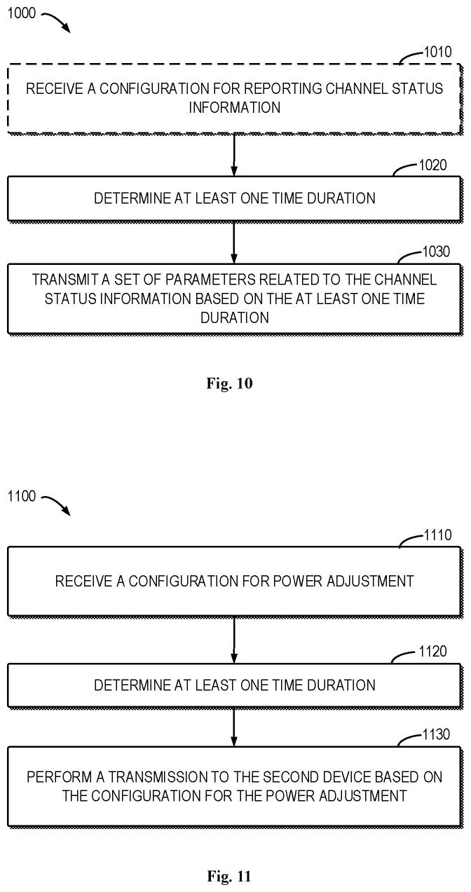

FIG. 10 shows a flowchart of an example method 1000 in accordance with some example embodiments of the present disclosure. For the purpose of discussion, the method 1000 will be described from the perspective of the first device 110-1.

In some embodiments, at block 1010, the first device 110-1 receives, from the second device 120, a configuration for reporting channel status information. In some embodiments, the configuration for reporting the channel status information comprises at least one of: information related to a reference interference level for determining the channel status information over the time duration, information related to a time slot index or a time period that the channel status information is related to, or information for a time slot index or time period that the set of parameter is related to.

At block 1020, the first device 110-1 determines a time duration for reporting the channel status information. In some embodiments, the first device 110-1 may determine a number of the time durations. In some embodiments, value of the channel status information is increasing within a first portion of the time duration, and the value of the channel status information is decreasing within a second portion of the time duration. In some embodiments, the first device 110-1 may determine the time duration based on the above configuration.

In some embodiments, the first device 110-1 may determine the time duration based on predictable received signal strength characteristics. Alternatively or in addition, the first device 110-1 may determine the time duration based on predictable movement of a NTN node (for example, a satellite). In other embodiments, the first device 110-1 may determine the time duration based on a predictable beam changing.

In some embodiments, the first device 110-1 may receive, from the second device 120, the information for beam changing. Alternatively or in addition, the first device 110-1 may receive, from the second device 120, the information for movement of NTN node. In other embodiments, the first device 110-1 may receive, from the second device 120, information for received signal strength characteristics. The above information can be transmitted in the above configuration. Alternatively, the above information can be transmitted separately from the above configuration.

At block 1030, the first device 110-1 transmits, to the second device 120, a set of one or more parameters related to the channel status information based on the time duration. In some embodiments, the first device 110-1 may transmit, to the second device 120, at least one of the following for the time duration: a maximum value of the channel status information, a minimum value of the channel status information, an increasing rate of the channel status information, a decreasing rate of the channel status information, a changing rate of the channel status information, a starting value of the channel status information, an ending value of the channel status information, or a changing pattern of the channel status information.

In some embodiments, the first device 110-1 may transmit, to the second device 120, at least one of the following for the time duration: a first time instant or time range for a maximum value of the channel status information, a second time instant or time range for a minimum value of the channel status information, a third time instant or time range for a starting value of the channel status information, or a fourth time instant or time range for an ending value of the channel status information.

In some embodiments, the first device 110-1 may determine a period for reporting the channel status information within the time duration. The first device may transmit the set of parameters for the at least one period.

In some embodiments, the first device 110-1 may transmit, to the second device 120, at least one channel status information as differential information to the set of parameter. In other embodiments, the first device 110-1 may transmit, to the second device 120, at least one channel status report in advance to a start of the time duration.

FIG. 11 shows a flowchart of an example method 1100 in accordance with some example embodiments of the present disclosure. For the purpose of discussion, the method 1100 will be described from the perspective of the first device 110.

At block 1110, the first device 110-1 receives, from the second device 120, a configuration for power adjustment. In some embodiments, the configuration comprises at least one of following for the time duration: a maximum value of the power adjustment, a minimum value of the power adjustment, an increasing rate of the power adjustment, a decreasing rate of the power adjustment, a changing rate of the power adjustment, a starting value of the power adjustment, an ending value of the power adjustment, or a changing pattern of the power adjustment.

In some embodiments, the confirmation comprises at least one of following for a the time duration: a first time instant for a maximum value of the power adjustment, a second time instant for a minimum value of the power adjustment, a third time instant for a starting value of the power adjustment, or a fourth time instant for an ending value of the power adjustment.

At block 1120, the first device 110-1 determines a time duration for the power adjustment. In some embodiments, the first device 110-1 may determine a number of the time durations. In some embodiments, a value of the power adjustment is decreasing within a first portion of the time duration, and the value of the power adjustment is increasing within a second portion of the time duration.

At block 1130, the first device 110-1 performs a transmission to the second device based on the configuration for the power adjustment and the time duration. In some embodiments, the first device 110-1 may receive, from the second device 120, a configuration of at least one differential information of power adjustment to the power adjustment. In some embodiments, the power adjustment is accumulated power adjustment.

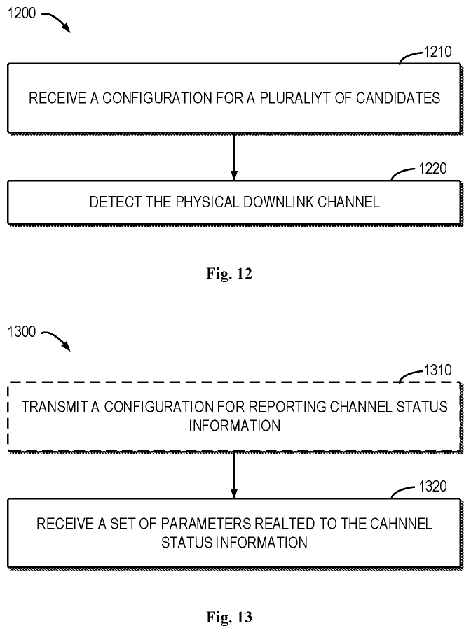

FIG. 12 shows a flowchart of an example method 1200 in accordance with some example embodiments of the present disclosure. For the purpose of discussion, the method 1200 will be described from the perspective of the first device 110.

At block 1210, the first device 110-1 receives, from the second device 120, a set of configurations for a plurality of candidates of a physical downlink channel for a set of aggregation levels associated with at least one time duration. In some embodiments, the at least one time duration is configured by the second device 120. Alternatively or in addition, the number of the at least one time duration is configured by the second device 120.

In some embodiments, the set of configurations indicates at least one of: a first number of candidates for at least a first aggregation level is increasing in a first part of the time duration and a second number of candidates for at least a second aggregation level is decreasing in the first part of the time duration, the first number of candidates for at least the first aggregation level is decreasing in a second part of the time duration and the second number of the candidates for at least the second aggregation level is increasing in the second part of the time duration, a number of candidates for at least one of aggregation level associated with each of the at least one time duration, a maximum number of candidates for at least one of aggregation level associated with each of the at least one time duration, a minimum number of candidates for at least one of aggregation level associated with each of the at least one time duration, or a changing rate for the candidates for at least one of aggregation level associated with each of the at least one time duration.

Alternatively or in addition, the set of configurations indicates at least one of: a first time instant or time range for a maximum number of candidates for at least one of aggregation level, a second time instant or time range for a minimum number of candidates for at least one of aggregation level, a third time instant or time range for a starting number of candidates for at least one of aggregation level, or a fourth time instant or time range for an ending number of candidates for at least one of aggregation level.

At block 1220, the first device 110-1 detects, based on the received set of configurations, the physical downlink channel for a corresponding aggregation level of the set of aggregation levels in the at least one time duration.

In some embodiments, the first device 110-1 may determine at least one period for detecting the physical downlink channel within the at least one time duration. In some embodiments, the first device 110-1 may receive, from the second device 120, a configuration of differential information of the number of candidates.

In some embodiments, values of the number of candidates for at least a first aggregation level can be alternately increasing and decreasing in the at least one time duration. Alternatively or in addition, the increasing part can last for a first portion of each time duration of the at least one time duration and the decreasing part can last for a second portion of each time duration of the at least one time duration. Alternatively or in addition, the increasing part can last for a part of time duration of the at least one time duration and the decreasing part can last for another part of time duration of the at least one time duration. The first device 110-1 can also determine a number of the time duration. Values of the number of candidates for at least a first aggregation level can be increasing within a first portion of each time duration of the at least one time duration and the values can be decreasing within a second portion of each time duration of the at least one time duration. Alternatively or in addition, values of the number of candidates for at least a first aggregation level can be increasing within a part of time duration of the at least one time duration and the values can be decreasing within another part of time duration of the at least one the time duration.

In some embodiments, the time duration could be corresponding to the time starting from a beam center serving the first device 110-1 to the beam edge serving the first device 110-1 or starting from a beam edge to the beam center, then the number of candidates for at least a first aggregation level may change continuously decreasing or increasing correspondingly. Or the time duration could be corresponding to the time starting from a beam edge serving the first device 110-1 to the beam another edge serving the first device 110-1, then the number of candidates for at least a first aggregation level may change firstly increasing then decreasing correspondingly or firstly decreasing then increasing correspondingly.

In this way, the first device 110-1 can interpret the number of candidates for at least a first aggregation level for the first device 110-1 in the entire time duration, e.g. considering the max or min value of the number of candidates for at least a first aggregation level and the changing rate of the number of candidates for at least a first aggregation level, the starting value could be the max or min value then changing as the changing rate.

FIG. 13 shows a flowchart of an example method 1300 in accordance with some example embodiments of the present disclosure. For the purpose of discussion, the method 1300 will be described from the perspective of the second device 120.

At block 1310, the second device 120 transmits, to the first device 110-1, a configuration for reporting channel status information. In some embodiments, the configuration for reporting the channel status information comprises at least one of: information related to a reference interference level for determining the channel status information over the at least one time duration, information related to a time slot index or a time period that the channel status information is related to, or information for a time slot index or time period that the set of parameter is related to.

At block 1310, the second device 120 receives, from the first device 110-1, a set of one or more parameters related to the channel status information for the duration determined based on the configuration. In some embodiments, the second device 120 may receive at least one of the followings for each time duration of the at least one time duration: a maximum value of the channel status information, a minimum value of the channel status information, an increasing rate of the channel status information, a decreasing rate of the channel status information, a changing rate of the channel status information, a starting value of the channel status information, an ending value of the channel status information, or a changing pattern of the channel status information.

In some embodiments, the second device 120 may receive at least one of the followings for each time duration of the at least one time duration: a first time instant or time range for a maximum value of the channel status information, a second time instant or time range for a minimum value of the channel status information, a third time instant or time range for a starting value of the channel status information, or a fourth time instant or time range for an ending value of the channel status information.

In some embodiments, the second device 120 may receive the set of parameters for at least one period in the at least one time duration. In some embodiments, the second device 120 may receive channel status information as differential information to the set of parameter.

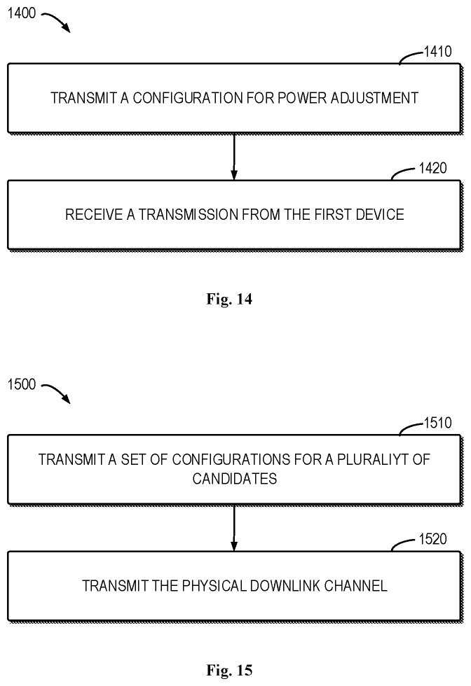

FIG. 14 shows a flowchart of an example method 1400 in accordance with some example embodiments of the present disclosure. For the purpose of discussion, the method 1400 will be described from the perspective of the second device 120.

At block 1410, the second device 120 transmits, to the first device 110-1, a configuration for power adjustment. In some embodiments, a value of the power adjustment is decreasing within a first portion of the at least one time duration, and the value of the power adjustment is increasing within a second portion of the at least one time duration.

In some embodiments, the configuration may comprise at least one of following for at least one of time duration of the at least one of time duration: a maximum value of the power adjustment, a minimum value of the power adjustment, an increasing rate of the power adjustment, a decreasing rate of the power adjustment, a changing rate of the power adjustment, a starting value of the power adjustment, an ending value of the power adjustment, or a changing pattern of the power adjustment.

In some embodiments, the configuration may comprise at least one of following for at least one of time duration of the at least one of time duration: a first time instant for a maximum value of the power adjustment, a second time instant for a minimum value of the power adjustment, a third time instant for a starting value of the power adjustment, or a fourth time instant for an ending value of the power adjustment.

At block 1410, the second device 120 receives a transmission from the first device based on the configuration for the power adjustment and at least one time duration for the power adjustment. In some embodiments, the second device 120 may transmit, to the first device 110-1, a configuration of at least one differential information of power adjustment to the power adjustment. In some embodiments, the power adjustment is accumulated power adjustment.

FIG. 15 shows a flowchart of an example method 1500 in accordance with some example embodiments of the present disclosure. For the purpose of discussion, the method 1500 will be described from the perspective of the second device 120.

At block 1510, the second device 120 transmits, to the first device 110-1, a set of configurations for a plurality of candidates a physical downlink channel for a set of aggregation levels associated with at least one time duration. In some embodiments, the at least one time duration is configured by the second device 120. Alternatively or in addition, the number of the at least one time duration is configured by the second device 120.

In some embodiments, the set of configurations may indicate at least one of: a first number of candidates for at least a first aggregation level is increasing in a first part of the at least one time duration and a second number of candidates for at least a second aggregation level is decreasing in the first part of the at least one time duration, and/or the first number of candidates for at least the first aggregation level is decreasing in a second part of the at least one time duration and the second number of the candidates for at least the second aggregation level is increasing in the second part of the at least one time duration, a number of candidates for at least one of aggregation level associated with each of the at least one time duration, a maximum number of candidates for at least one aggregation level associated with each of the at least one time duration, a minimum number of candidates for at least one aggregation level associated with each of the at least one time duration, or a changing rate for the number of candidates for at least one aggregation level associated with each of the at least one time duration.

In some embodiments, the set of configurations indicates at least one of: a first time range for a maximum number of candidates for at least one aggregation level, a second time range for a minimum number of candidates for at least one aggregation level, a third time range for a starting number of candidates for at least one aggregation level, or a fourth time range for an ending number of candidates for at least one aggregation level.

At block 1520, the second device 120 transmits, to the first device 110-1, to the first device, the physical downlink channel for a corresponding aggregation level of the set of aggregation levels on a corresponding time duration in the at least one time duration. In some embodiments, the second device 120 may transmit, to the first device 110-1, a configuration of at least one differential information of the number of candidates.

In some example embodiments, an apparatus capable of performing any of the methods 1000, 1100, 1200 (for example, the first device 110) may comprise means for performing the respective operations of the methods 1000, 1100, 1200. The means may be implemented in any suitable form. For example, the means may be implemented in a circuitry or software module. The first apparatus may be implemented as or included in the first device 110. In some example embodiments, the means may comprise at least one processor and at least one memory including computer program code. The at least one memory and computer program code are configured to, with the at least one processor, cause performance of the apparatus.

In some example embodiments, the first apparatus comprises means for determining a time duration for reporting channel status information; and means for transmitting, to the second device, a set of one or more parameters related to the channel status information based on the time duration.

In some example embodiments, the means for transmitting the set of one or more parameters related to the channel status information comprises: means for transmitting, to the second device, at least one of the following for the time duration: a maximum value of the channel status information, a minimum value of the channel status information, an increasing rate of the channel status information, a decreasing rate of the channel status information, a changing rate of the channel status information, a starting value of the channel status information, an ending value of the channel status information, or a changing pattern of the channel status information.

In some example embodiments, the means for transmitting the one or more set of parameters related to the channel status information comprises: transmitting, to the second device, at least one of the following for the time duration: a first time instant or time range for a maximum value of the channel status information, a second time instant or time range for a minimum value of the channel status information, a third time instant or time range for a starting value of the channel status information, or a fourth time instant or time range for an ending value of the channel status information.

In some example embodiments, the first apparatus comprises means for receiving, from a second device, a configuration for reporting channel status information, wherein the configuration for reporting the channel status information comprises at least one of: information related to a reference interference level for determining the channel status information for the time duration, information related to a time slot index or a time period that the channel status information is related to, or information for a time slot index or time period that the set of one or more parameters is related to; and the means for determining the time duration comprises: means for determining the at least one time duration based on the received configuration.

In some example embodiments, the means for determining the time duration comprises: determining number of the time duration.

In some example embodiments, value of the channel status information is increasing within a first portion of the time duration, and/or the value of the channel status information is decreasing within a second portion of the time duration.

In some embodiments, the first apparatus comprises means for determining at least one period for reporting the channel status information within the at least one time duration; and the means for transmitting the set of parameters related to the channel status information comprises: means for transmitting the set of parameters for the at least one period.

In some embodiments, a size of the period is continuously increasing in part of the time duration, or the size of the period is continuously decreasing in part of the time duration, or the size of the period is continuously increasing or decreasing in the time duration.

In some embodiments, the first apparatus comprises means for transmitting, to the second device, at least one channel status information as differential information to the set of one or more parameters.

In some embodiments, the first apparatus comprises means for transmitting, to the second device, at least one channel status information report in advance to a start of the time duration.

In some example embodiments, the first apparatus comprises means for receiving, at a first device and from a second device, a configuration for power adjustment; means for determining a time duration for the power adjustment; and means for performing a transmission to the second device based on the configuration for the power adjustment during the time duration.

In some example embodiments, the means for determining the at least one time duration comprises: means for determining number of the time duration.

In some example embodiments, a value of the power adjustment is decreasing within a first portion of the time duration, and/or the value of the power adjustment is increasing within a second portion of the duration.

In some example embodiments, the configuration comprises at least one of following the time duration: a maximum value of the power adjustment, a minimum value of the power adjustment, an increasing rate of the power adjustment, a decreasing rate of the power adjustment, a changing rate of the power adjustment, a starting value of the power adjustment, an ending value of the power adjustment, or a changing pattern of the power adjustment.

In some example embodiments, the confirmation comprises at least one of following for the time duration: a first time instant or time range for a maximum value of the power adjustment, a second time instant or time range for a minimum value of the power adjustment, a third time instant or time range for a starting value of the power adjustment, or a fourth time instant or time range for an ending value of the power adjustment.

In some example embodiments, the first apparatus further comprises means for determining at least one period for the power adjustment within the time duration.

In some example embodiments, a size of the period is continuously increasing in part of the time duration, or the size of the period is continuously decreasing in part of the time duration, or the size of the period is continuously increasing or decreasing in the time duration.

In some example embodiments, the power adjustment is accumulated power adjustment.

In some example embodiments, the first device is a terminal device and the second device is a network device, or wherein the first device is a terrestrial communication device and the second device is a non-terrestrial communication device.

In some example embodiments, the first apparatus comprises means for receiving, at a first device and from a second device, a set of configurations for a number of candidates of a physical downlink channel for a set of aggregation levels associated with at least one time duration; and means for detecting, at the first device, the physical downlink channel for a corresponding aggregation level of the set of aggregation levels in the at least one time duration.

In some example embodiments, the at least one time duration is configured by the second device, and/or the number of the at least one time duration is configured by the second device.

In some example embodiments, the set of configurations indicates at least one of: a first number of candidates for at least a first aggregation level is increasing in a first part of the at least one time duration and a second number of candidates for at least a second aggregation level is decreasing in the first part of the at least one time duration, and/or the first number of candidates for at least the first aggregation level is decreasing in a second part of the at least one time duration and the second number of the candidates for at least the second aggregation level is increasing in the second part of the at least one time duration, a number of candidates for at least one of aggregation level associated with each of the at least one time duration, a maximum number of candidates for at least one aggregation level associated with each of the at least one time duration, a minimum number of candidates for at least one aggregation level associated with each of the at least one time duration, or a changing rate for the number of candidates for at least one aggregation level associated with each of the at least one time duration.

In some example embodiments, the set of configurations indicates at least one of: a first time range for a maximum number of candidates for at least one aggregation level, a second time range for a minimum number of candidates for at least one aggregation level, a third time range for a starting number of candidates for at least one aggregation level, or a fourth time range for an ending number of candidates for at least one aggregation level.

In some example embodiments, the first apparatus further comprises means for receiving, from the second device, a configuration of at least one differential information of the number of candidates.

In some example embodiments, the first device is a terminal device and the second device is a network device, or wherein the first device is a terrestrial communication device and the second device is a non-terrestrial communication device.

In some example embodiments, an apparatus capable of performing any of the methods 1300, 1400, 1500 (for example, the second device 120) may comprise means for performing the respective operations of the methods 1300, 1400, 1500. The means may be implemented in any suitable form. For example, the means may be implemented in a circuitry or software module. The first apparatus may be implemented as or included in the second device 120. In some example embodiments, the means may comprise at least one processor and at least one memory including computer program code. The at least one memory and computer program code are configured to, with the at least one processor, cause performance of the apparatus.

In some example embodiments, the second apparatus comprises means for receiving, at a second device and from a first device, a set of one or more parameters related to channel status information for a time duration.

In some example embodiments, the means for receiving the set of parameters related to the channel status information comprises: means for receiving, from the first device, at least one of the followings for the time duration: a maximum value of the channel status information, a minimum value of the channel status information, an increasing rate of the channel status information, a decreasing rate of the channel status information, a changing rate of the channel status information, a starting value of the channel status information, an ending value of the channel status information, or a changing pattern of the channel status information.

In some example embodiments, the means for receiving the set of parameters related to the channel status information comprises: receiving, from the first device, at least one of the followings for the time duration: a first time instant or time range for a maximum value of the channel status information, a second time instant or time range for a minimum value of the channel status information, a third time instant or time range for a starting value of the channel status information, or a fourth time instant or time range for an ending value of the channel status information.

In some example embodiments, the means for receiving the set of parameters related to the channel status information comprises: receiving the set of parameters for at least one period in the at least one time duration.

In some embodiments, the second apparatus comprises means for receiving, from the first device, at least one channel status information as differential information to the set of parameter.

embodiments, the second apparatus comprises means for receiving, from the first device, at least one channel status information report in advance to a start of the time duration.

In some example embodiments, the second apparatus comprises means for transmitting, at a second device and to a first device, a configuration for power adjustment; and means for receiving a transmission from the first device based on the configuration for the power adjustment and the time duration for the power adjustment.

In some example embodiments, a value of the power adjustment is decreasing within a first portion of the time duration, and/or the value of the power adjustment is increasing within a second portion of the time duration.

In some example embodiments, the configuration comprises at least one of following for at least one of time duration of the at least one of time duration: a maximum value of the power adjustment, a minimum value of the power adjustment, an increasing rate of the power adjustment, a decreasing rate of the power adjustment, a changing rate of the power adjustment, a starting value of the power adjustment, an ending value of the power adjustment, or a changing pattern of the power adjustment.

In some example embodiments, the confirmation comprises at least one of following for the time duration of the at least one of time duration: a first time instant or time range for a maximum value of the power adjustment, a second time instant or time range for a minimum value of the power adjustment, a third time instant or time range for a starting value of the power adjustment, or a fourth time instant or time range for an ending value of the power adjustment.

In some example embodiments, the second apparatus further comprises means for transmitting, to the first device, a configuration of at least one differential information of power adjustment to the power adjustment.

In some example embodiments, the power adjustment is accumulated power adjustment.

In some example embodiments, the first device is a terminal device and the second device is a network device, or the first device is a terrestrial communication device and the second device is a non-terrestrial communication device.

In some example embodiments, the second apparatus comprises means for transmitting, at a second device and to a first device, a set of configurations for a plurality of candidates a physical downlink channel for a set of aggregation levels associated with at least one time durations; and means for transmitting, to the first device, the physical downlink channel for a corresponding aggregation level of the set of aggregation levels in the at least one time duration.

In some example embodiments, the at least one time duration is configured by the second device, and/or the number of the at least one time duration is configured by the second device.

In some example embodiments, the set of configurations indicates at least one of: a first number of candidates for at least a first aggregation level is increasing in a first part of the at least one time duration and a second number of candidates for at least a second aggregation level is decreasing in the first part of the at least one time duration, and/or, the first number of candidates for at least the first aggregation level is decreasing in a second part of the at least one time duration and the second number of the candidates for at least the second aggregation level is increasing in the second part of the at least one time duration, a number of candidates for at least one of aggregation level associated with each of the at least one time duration, a maximum number of candidates for at least one aggregation level associated with each of the at least one time duration, a minimum number of candidates for at least one aggregation level associated with each of the at least one time duration, or a changing rate for the number of candidates for at least one aggregation level associated with each of the at least one time duration.

In some example embodiments, the set of configurations indicates at least one of: a first time range for a maximum number of candidates for at least one aggregation level, a second time range for a minimum number of candidates for at least one aggregation level, a third time range for a starting number of candidates for at least one aggregation level, or a fourth time range for an ending number of candidates for at least one aggregation level.

In some example embodiments, the second apparatus further comprise mans for transmitting, to the first device, a configuration of at least one differential information of the number of candidates.

In some example embodiments, the first device is a terminal device and the second device is a network device, or the first device is a terrestrial communication device and the second device is a non-terrestrial communication device.

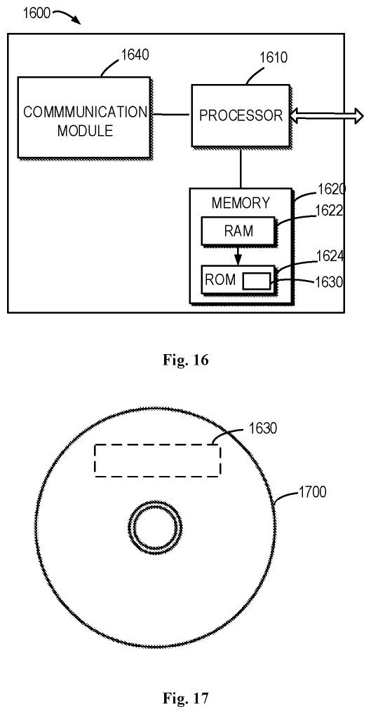

FIG. 16 is a simplified block diagram of a device 1600 that is suitable for implementing example embodiments of the present disclosure. The device 1600 may be provided to implement a communication device, for example, the first device 110 or the second device 120 as shown in FIG. 1. As shown, the device 1600 includes one or more processors 1610, one or more memories 1620 coupled to the processor 1610, and one or more communication modules 1640 coupled to the processor 1610.

The communication module 1640 is for bidirectional communications. The communication module 1640 has one or more communication interfaces to facilitate communication with one or more other modules or devices. The communication interfaces may represent any interface that is necessary for communication with other network elements. In some example embodiments, the communication module 1640 may include at least one antenna.

The processor 1610 may be of any type suitable to the local technical network and may include one or more of the following: general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

The memory 1620 may include one or more non-volatile memories and one or more volatile memories. Examples of the non-volatile memories include, but are not limited to, a Read Only Memory (ROM) 1624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1622 and other volatile memories that will not last in the power-down duration.

A computer program 1630 includes computer executable instructions that are executed by the associated processor 1610. The program 1630 may be stored in the memory, e.g., ROM 1624. The processor 1610 may perform any suitable actions and processing by loading the program 1630 into the RAM 1622.

Example embodiments of the present disclosure may be implemented by means of the program 1630 so that the device 1600 may perform any process of the disclosure as discussed with reference to FIGS. 3 to 15. The example embodiments of the present disclosure may also be implemented by hardware or by a combination of software and hardware.

In some example embodiments, the program 1630 may be tangibly contained in a computer readable medium which may be included in the device 1600 (such as in the memory 1620) or other storage devices that are accessible by the device 1600. The device 1600 may load the program 1630 from the computer readable medium to the RAM 1622 for execution. The computer readable medium may include any types of tangible non-volatile storage, such as ROM, EPROM, a flash memory, a hard disk, CD, DVD, and other magnetic storage and/or optical storage. FIG. 17 shows an example of the computer readable medium 1700 in form of an optical storage disk. The computer readable medium has the program 1630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 3 to 15. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-35. (canceled)

36. A method, comprising:
determining, at a first device, a time duration for reporting channel status information; and
transmitting, from the first device to a second device, a set of one or more parameters related to the channel status information based on the time duration.

37. The method of claim 36, wherein transmitting the set of one or more parameters related to the channel status information comprises:
transmitting, to the second device, at least one of the following for the time duration:
a maximum value of the channel status information,
a minimum value of the channel status information,
an increasing rate of the channel status information,
a decreasing rate of the channel status information,
a changing rate of the channel status information,
a starting value of the channel status information,
an ending value of the channel status information, or
a changing pattern of the channel status information.

38. The method of claim 36, wherein transmitting the one or more set of parameters related to the channel status information comprises:
transmitting, to the second device, at least one of the following for the time duration:
a first time instant or time range for a maximum value of the channel status information,
a second time instant or time range for a minimum value of the channel status information,
a third time instant or time range for a starting value of the channel status information, or
a fourth time instant or time range for an ending value of the channel status information.

39. The method of claim 36, further comprising:
receiving, from a second device, a configuration for reporting channel status information, wherein determining the time duration comprises determining the time duration based on the received configuration, and wherein the configuration for reporting the channel status information comprises at least one of:
information related to a reference interference level for determining the channel status information for the time duration,
information related to a time slot index or a time period that the channel status information is related to, or
information for a time slot index or time period that the set of one or more parameters is related to.

40. The method of claim 36, wherein determining the time duration comprises:
determining a plurality of the time durations; and
transmitting, to the second device, a set of one or more parameters related to the channel status information for each of the time durations.

41. The method of claim 36, wherein at least one of: value of the channel status information is increasing within a first portion of the time duration, or the value of the channel status information is decreasing within a second portion of the time duration.

42. The method of claim 36, further comprising:
determining at least one period for reporting the channel status information within the time duration; and wherein transmitting the set of parameters related to the channel status information comprises transmitting the set of parameters for the at least one period.

43. The method of claim 36, further comprising:
transmitting, to the second device, channel status information as differential information to the set of one or more parameters.

44. The method of claim 36, further comprising:
transmitting, to the second device, at least one channel status information report in advance to a start of the time duration.

45. An apparatus, comprising:
at least one processor; and
at least one memory including computer program code;
wherein the at least one memory and the computer program code are configured to, with the at least one processor, cause the apparatus to:
determine a time duration for reporting channel status information; and
transmit, from a first device to a second device, a set of one or more parameters related to the channel status information based on the time duration.

46. The apparatus of claim 45, wherein transmitting the set of one or more parameters related to the channel status information comprises:
transmitting, to the second device, at least one of the following for the time duration:
a maximum value of the channel status information,
a minimum value of the channel status information,
an increasing rate of the channel status information,
a decreasing rate of the channel status information,
a changing rate of the channel status information,
a starting value of the channel status information,
an ending value of the channel status information, or
a changing pattern of the channel status information.

47. The apparatus of claim 45, wherein transmitting the one or more set of parameters related to the channel status information comprises:
transmitting, to the second device, at least one of the following for the time duration:
a first time instant or time range for a maximum value of the channel status information,
a second time instant or time range for a minimum value of the channel status information,
a third time instant or time range for a starting value of the channel status information, or
a fourth time instant or time range for an ending value of the channel status information.

48. The apparatus of claim 45, wherein the at least one memory and the computer program code are configured to, with the at least one processor, cause the apparatus further to:
receive, from a second device, a configuration for reporting channel status information, wherein the configuration for reporting the channel status information comprises at least one of:
information related to a reference interference level for determining the channel status information for the time duration,
information related to a time slot index or a time period that the channel status information is related to, or
information for a time slot index or time period that the set of one or more parameters is related to.

49. The apparatus of claim 45, wherein determining the time duration comprises:
determining the time duration based on the received configuration.

50. The apparatus of claim 45, wherein determining the time duration comprises:
determining a plurality of the time durations; and
transmitting, to the second device, a set of one or more parameters related to the channel status information for each of the time durations.

51. The apparatus of claim 45, wherein at least one of: value of the channel status information is increasing within a first portion of the time duration, or the value of the channel status information is decreasing within a second portion of the time duration.

52. The apparatus of claim 45, wherein the at least one memory and the computer program code are configured to, with the at least one processor, cause the apparatus further to:
determine at least one period for reporting the channel status information within the time duration; and wherein transmitting the set of parameters related to the channel status information comprises transmitting the set of parameters for the at least one period.

53. The apparatus of claim 45, wherein the at least one memory and the computer program code are configured to, with the at least one processor, cause the apparatus further to:
transmit, to the second device, channel status information as differential information to the set of one or more parameters.

54. The apparatus of claim 45, wherein the at least one memory and the computer program code are configured to, with the at least one processor, cause the apparatus further to:
transmit, to the second device, at least one channel status information report in advance to a start of the time duration.

55. The apparatus of claim 45, wherein the first device is a terrestrial communication device and the second device is a non-terrestrial communication device.
